(19) United States
(12) Patent Application Publication
(10) Pub. No.: US 2021/0389823 A1
(43) Pub. Date: Dec. 16, 2021

(54) INFORMATION PROCESSOR, INFORMATION PROCESSING METHODS, AND STORAGE MEDIUM

(71) Applicant: SONY GROUP CORPORATION, Tokyo (JP)

(72) Inventor: Ryo YOKOYAMA, Tokyo (JP)

(73) Assignee: SONY GROUP CORPORATION, Tokyo (JP)

(21) Appl. No.: 17/287,009

(22) PCT Filed: Oct. 30, 2019
(86) PCT No.: PCT/JP2019/042474

§ 371 Date: Apr. 20, 2021

(30) Foreign Application Priority Data
Nov. 14, 2018 (JP) 2018-213998

(51) Int. Cl. G06F 3/01; G06F 3/16; G08B 6/00

(52) U.S. Cl. CPC G06F 3/016; G08B 6/00; G06F 3/16

(57) ABSTRACT

There is provided an information processor including a perception control section that allows, on a basis of a position of a user and a desired tactile stimulus presentation position, the user to perceive a direction of propagation of the tactile stimulus relative to the user, by an auditory effect or a visual effect.

### TECHNICAL FIELD

The present disclosure relates to an information processor, an information processing method, and a storage medium.

### BACKGROUND ART

In recent years, there have been developed various techniques that utilize a tactile stimulus such as a vibration. For example, PTL 1 listed below discloses a speaker apparatus that includes an actuator functioning as a vibration source and propagates a vibration generated in the actuator to a diaphragm to thereby output a sound.

### CITATION LIST

### Patent Literature

PTL 1: Japanese Unexamined Patent Application Publication No. 2012-105021

### SUMMARY OF THE INVENTION

### Problem to be Solved by the Invention

The technique, etc. disclosed in PTL 1 enables utilization of a vibration, which is one type of the tactile stimulus, as a sound output, but does not enable a user to properly perceive a direction of propagation of the tactile stimulus.

The present disclosure has therefore been made in view of the above-described circumstances, and provides an information processor, an information processing method, and a storage medium that are novel and improved and that enables a user to more properly perceive a direction of propagation of a tactile stimulus relative to the user

### Means for Solving the Problem

According to the present disclosure, there is provided an information processor including a perception control section that allows, on a basis of a position of a user and a desired tactile stimulus presentation position, the user to perceive a direction of propagation of the tactile stimulus relative to the user, by an auditory effect or a visual effect.

In addition, according to the present disclosure, there is provided an information processing method executed by a computer, the method including allowing, on a basis of a position of a user and a desired tactile stimulus presentation position, the user to perceive a direction of propagation of the tactile stimulus relative to the user, by an auditory effect or a visual effect.

In addition, according to the present disclosure, there is provided a storage medium storing a program that causes a computer to implement allowing, on a basis of a position of a user and a desired tactile stimulus presentation position, the user to perceive a direction of propagation of the tactile stimulus relative to the user, by an auditory effect or a visual effect.

### BRIEF DESCRIPTION OF THE DRAWINGS

FIG. 1 illustrates a specific example of a tactile presentation apparatus according to the present embodiment.

FIG. 2 illustrates a specific example of an arrangement of tactile presentation apparatuses according to the present embodiment.

FIG. 3 illustrates a specific example of a content provided by using the tactile presentation apparatuses according to the present embodiment.

FIG. 4 is an explanatory diagram in which the tactile presentation apparatus according to the present embodiment controls presentation of a tactile stimulus depending on the way a user steps.

FIG. 5 is a block diagram illustrating a configuration example of an information processing system according to the present embodiment.

FIG. 6 is a block diagram illustrating a configuration example of the information processing system according to the present embodiment.

FIG. 7 is an explanatory diagram of an overview of functions of the information processing system according to the present embodiment.

FIG. 8 is an explanatory diagram of an overview of the functions of the information processing system according to the present embodiment.

FIG. 9 is an explanatory diagram of an overview of the functions of the information processing system according to the present embodiment.

FIG. 10 is an explanatory diagram of an overview of the functions of the information processing system according to the present embodiment.

FIG. 11 is a block diagram illustrating a configuration example of a host apparatus according to the present embodiment.

FIG. 12 is a block diagram illustrating a configuration example of the tactile presentation apparatus according to the present embodiment.

FIG. 13 is a flowchart illustrating an example of a processing flow of each apparatus according to the present embodiment, when presenting a tactile stimulus and an auditory or visual effect.

FIG. 14 is an explanatory diagram of an overview of functions of an information processing system according to a first modification example.

FIG. 15 is an explanatory diagram of an overview of the functions of the information processing system according to the first modification example.

FIG. 16 is a flowchart illustrating an example of a processing flow of each apparatus according to the first modification example, when presenting a tactile stimulus.

FIG. 17 is an explanatory diagram of an overview of functions of an information processing system according to a second modification example.

FIG. 18 is an explanatory diagram of an overview of the functions of the information processing system according to the second modification example.

FIG. 19 is an explanatory diagram of an overview of functions of an information processing system according to a third modification example.

FIG. 20 is an explanatory diagram of an information processing system according to a fourth modification example.

FIG. 21 is an explanatory diagram of an overview of functions of the information processing system according to the fourth modification example.

FIG. 22 is a block diagram illustrating a hardware configuration example of the tactile presentation apparatus or the host apparatus according to the present embodiment.

### MODES FOR CARRYING OUT THE INVENTION

Hereinafter, description is given in detail of preferred embodiments of the present disclosure with reference to the accompanying drawings. It is to be noted that, in the present specification and drawings, repeated description is omitted for components substantially having the same functional configuration by assigning the same reference numerals.

It is to be noted that the description is given in the following order.

### 1. Overview

### 2. Configuration Example of Each Apparatus

### 3. Example of Processing Flow of Each Apparatus

### 4. Modification Examples

### 5. Hardware Configuration Example

### 6. Conclusion

### 1. Overview

First, description is given of an overview of an embodiment according to the present disclosure.

### 1.1. Overview of Tactile Presentation Apparatus

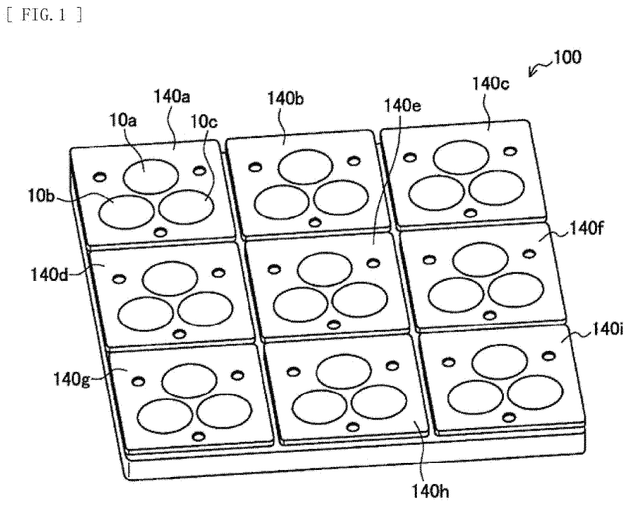

FIG. 1 illustrates a specific example of a tactile presentation apparatus 100 according to the present embodiment. The tactile presentation apparatus 100 includes a plurality of tactile presentation units 140 (a tactile presentation unit 140a to a tactile presentation unit 140i in the example of FIG. 1) that present tactile stimuli; controlling these tactile presentation units 140 enables presentation of a tactile stimulus to any target. It is to be noted that the number or arrangement of the tactile presentation units 140 included in the tactile presentation apparatus 100 is not particularly limited.

As used herein, the “tactile stimulus” presented by the tactile presentation unit 140 includes, for example, a vibration, but is not necessarily limited thereto, and may include, for example, a stimulus related to a temperature, a stimulus related to a force sense, an electric stimulus, or the like (i.e., a plurality of types of tactile stimuli may be presented). In the following, description is given mainly of a case where the tactile stimulus is a vibration. More specifically, as illustrated in FIG. 1, the tactile presentation unit 140 is provided with actuators 10 (an actuator 10a to an actuator 10c in the example of FIG. 1) near a surface thereof; vibrating the actuators 10 enables presentation of a vibration to any target. It is to be noted that the number or arrangement of the actuators 10 included in the tactile presentation unit 140 is not particularly limited. In addition, in a case where a tactile stimulus to be presented is other than a vibration, the tactile presentation units 140 is provided with a required configuration depending on the type of the tactile stimulus to be presented.

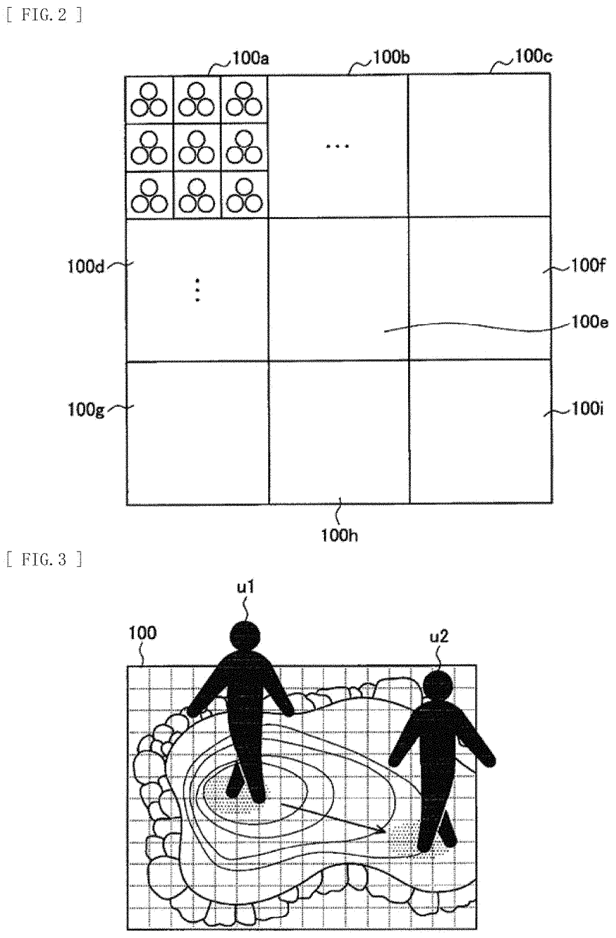

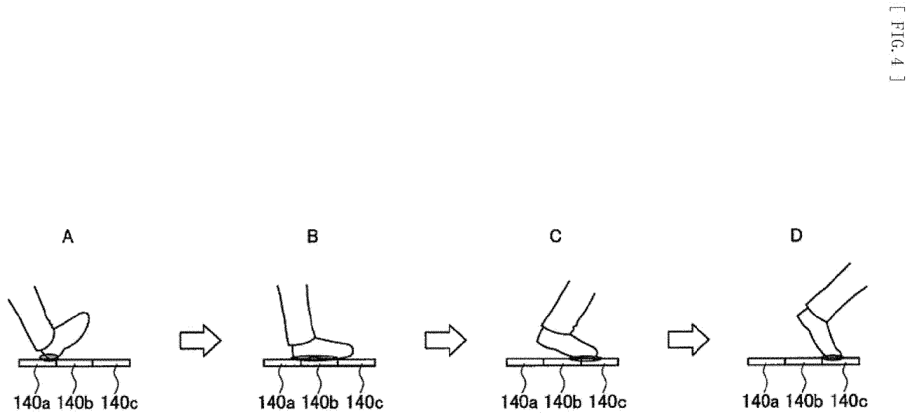

In the present embodiment, as illustrated in FIG. 2, a plurality of tactile presentation apparatuses 100 (a tactile presentation apparatus 100a to a tactile presentation apparatus 100i in the example of FIG. 2) are arranged on the ground in a state of close proximity to one another. This enables an information processing system according to the present embodiment to present a vibration to any target (e.g., a user) on these tactile presentation apparatuses 100. For example, suppose, as illustrated in FIG. 3, that an image of a “pond” is displayed on the plurality of tactile presentation apparatuses 100 (the tactile presentation apparatuses 100 may display the image on their own, or an external projector may project the image onto the tactile presentation apparatuses 100) and that a user u1 and a user u2 are on these tactile presentation apparatuses 100. Then, in a case where the user u1 walks in a region where the image of the pond is displayed, the tactile presentation apparatus 100 positioned at the foot of the user u1 (tactile presentation apparatus 100 in contact with the user u1) presents a vibration to the user u1 to thereby cause the user u1 to have perception of walking in the pond (active presentation of a tactile stimulus). Meanwhile, the tactile presentation apparatus 100 positioned at the foot of the user u2 (tactile presentation apparatus 100 in contact with the user u2) presents a vibration to the user u2 to thereby cause the user u2 to perceive an impact of a crash of a wave generated and propagated as a result of the user u1 walking in the pond (passive presentation of a tactile stimulus).

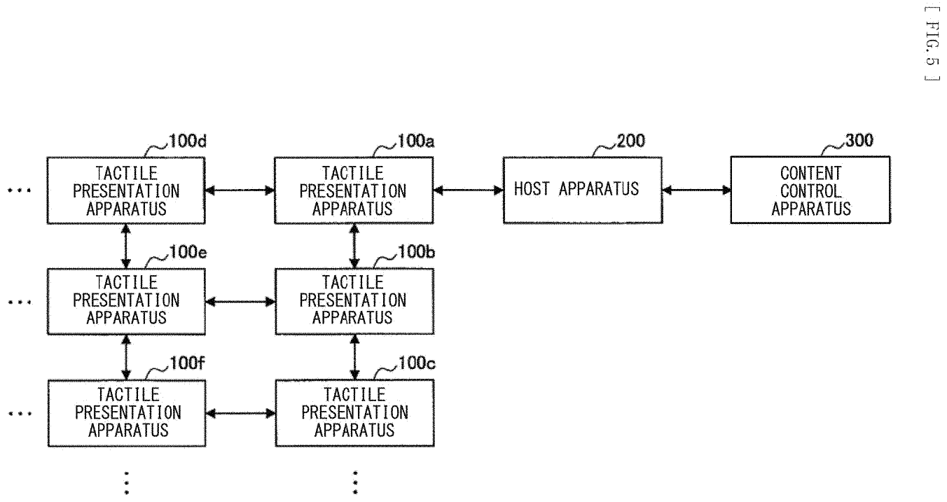

In addition, the tactile presentation units 140 may each include not only the actuator 10 but also a pressure-sensitive sensor. This enables the tactile presentation apparatus 100 to output not only whether or not a presentation target of the tactile stimulus is stepping on the tactile presentation apparatus 100, but also stepping force, a range and an area to which the force is applied, and the like, thus making it possible to control the type, intensity, or the like of a vibration to be presented depending on results of these outputs. For example, as illustrated in FIG. 4, when the user walks on a location from the tactile presentation unit 140a to the tactile presentation unit 140c, weight shift is assumed to be performed in the order of the heel (A of FIG. 4), the rear of the sole (B of FIG. 4), the front of the sole (C of FIG. 4), and the toe (D of FIG. 4). In this case, force (stepping force) applied to the tactile presentation units 140, a range and an area to which the force is applied, and the like differ in each of A to D of FIG. 4. Therefore, the tactile presentation apparatus 100 uses each of the tactile presentation units 140 (the tactile presentation unit 140a to the tactile presentation unit 140c in the case of FIG. 4) depending on the stepping force, the range and the area to which the force is applied, and the like to control the type, intensity, or the like of a vibration to be presented, thereby making it possible to achieve a variety of representations of tactile senses. For example, the tactile presentation apparatus 100 enables a user to have a perception of walking on sand or snow.

It is to be noted that the description is given above to the effect that the plurality of tactile presentation apparatuses 100 are placed on the ground in a state of close proximity to one another. It should be noted, however, that the phrase “in a state of close proximity to one another” refers to being positioned at a very close distance to one another, but does not necessarily mean being in contact with each other. In addition, the plurality of tactile presentation apparatuses 100 may not necessarily be arranged on the ground, but may be arranged in, for example, a wear worn by a user (no limitation is placed on the wear as a matter of course). In addition, the presentation target of a tactile stimulus is not particularly limited, and may be, for example, a user (human), an animal, or various objects (e.g., a robot, a vehicle, etc.). In the following, description is given by exemplifying a case where the user is the presentation target of the tactile stimulus.

### 1.2. Configuration Example of Information Processing System

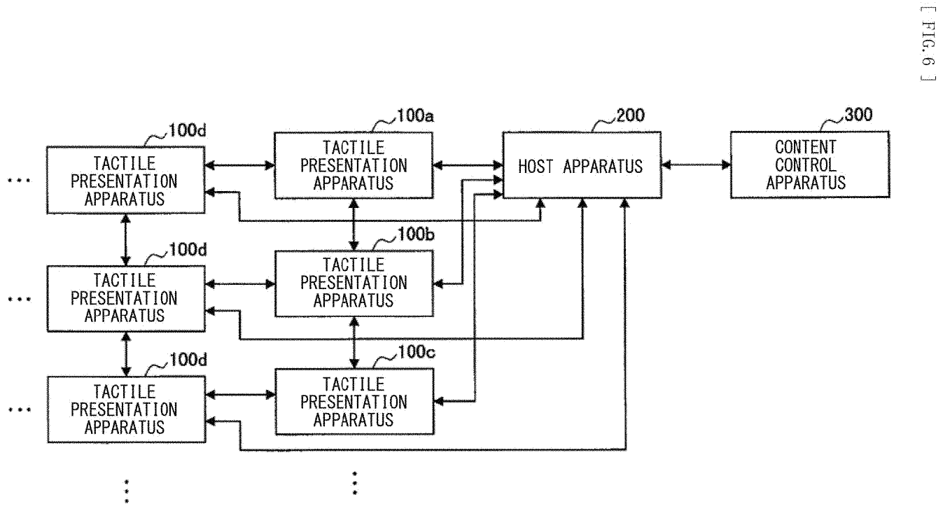

FIG. 5 illustrates a configuration example of an information processing system according to the present embodiment. As illustrated in FIG. 5, the information processing system according to the present embodiment includes the plurality of tactile presentation apparatuses 100 described above, a host apparatus 200, and a content control apparatus 300

The content control apparatus 300 is an apparatus that controls the entire content provided by the information processing system according to the present embodiment. More specifically, the content control apparatus 300 decides the type, substance, and the like of the content to be provided to the user, and progresses the content. It is to be noted that the “content” includes, but not necessarily limited to, an experience-based attraction, a game, a concert, a play, or the like, for example. As illustrated in FIG. 5, the content control apparatus 300 is coupled for communication to the host apparatus 200, and transmits information concerning a progression status of the content to the host apparatus 200 when deciding the type, substance, and the like of the content and progressing the content.

The host apparatus 200 is an apparatus (information processor) that controls providing of a tactile stimulus by the tactile presentation apparatus 100 as the content progresses. More specifically, the host apparatus 200 receives information concerning the progression status of the content from the content control apparatus 300, and generates tactile presentation information used for the providing of the tactile stimulus by the tactile presentation apparatus 100 on the basis of the information. As illustrated in FIG. 5, the host apparatus 200 is coupled for communication to at least one of the plurality of tactile presentation apparatuses 100, and transmits the generated tactile presentation information to the tactile presentation apparatus 100. The host apparatus 200 continues the generation of the tactile presentation information and the transmission thereof to the tactile presentation apparatus 100 until the end of the content.

The tactile presentation apparatus 100 is an apparatus (information processor) that presents a tactile stimulus to any target. More specifically, the plurality of tactile presentation apparatuses 100 are arranged on the ground in a state of close proximity to one another as described above, and present vibrations to any target thereon (e.g., a user, etc.) on the basis of the tactile presentation information transmitted from the host apparatus 200.

Here, the plurality of tactile presentation apparatuses 100 includes a first tactile presentation apparatus that, in a case of receiving tactile presentation information from the host apparatus 200, transmits the tactile presentation information to a peripheral tactile presentation apparatus 100, and a second tactile presentation apparatus that, in a case of receiving the tactile presentation information from the peripheral tactile presentation apparatus 100, presents a tactile stimulus on the basis of the tactile presentation information.

The first tactile presentation apparatus is the tactile presentation apparatus 100 (tactile presentation apparatus 100a in the example of FIG. 5) coupled for communication to the host apparatus 200 among the plurality of tactile presentation apparatuses 100, and transmits information (e.g., tactile presentation information) received from the host apparatus 200 to other tactile presentation apparatuses 100 to thereby diffuse the information among the plurality of tactile presentation apparatuses 100. That is, the first tactile presentation apparatus serves as a starting point when the information transmitted from the host apparatus 200 is diffused among the plurality of tactile presentation apparatuses 100. In addition, the first tactile presentation apparatus transmits information received from another tactile presentation apparatus 100 to the host apparatus 200.

The second tactile presentation apparatus is the tactile presentation apparatus 100 that presents a tactile stimulus to any target on the basis of the tactile presentation information diffused among the plurality of tactile presentation apparatuses 100. More specifically, a plurality of second tactile presentation apparatuses exist in the system, and present a tactile stimulus in conjunction with one another on the basis of the tactile presentation information to thereby present a tactile stimulus to be propagated to a presentation target of the tactile stimulus. It is to be noted that each of the tactile presentation apparatuses 100 may function as the first tactile presentation apparatus, may function as the second tactile presentation apparatus, or may function as both of the first tactile presentation apparatus and the second tactile presentation apparatus. In the example of FIG. 5, all of the tactile presentation apparatuses 100 (tactile presentation apparatuses 100a to tactile presentation apparatus 100f) may function as the second tactile presentation apparatus.

In this manner, on the basis of the tactile presentation information diffused from the first tactile presentation apparatus as the starting point, the second tactile presentation apparatus presents the tactile stimulus, thereby reducing a processing load of the host apparatus 200. For example, it becomes unnecessary for the host apparatus 200 to individually generate and transmit the tactile presentation information to the tactile presentation apparatus 100 (second tactile presentation apparatus) that presents the tactile stimulus.

It is to be noted that the configuration illustrated in FIG. 5 is merely an example, and the configuration example of the information processing system according to the present embodiment is not necessarily limited to the example of FIG. 5. For example, the host apparatus 200 and the content control apparatus 300 may be achieved by a single apparatus. In addition, as illustrated in FIG. 6, the host apparatus 200 may be coupled for communication to the plurality of tactile presentation apparatuses 100 (tactile presentation apparatus 100a to tactile presentation apparatus 100f). In the case of FIG. 6, the tactile presentation apparatuses 100 (tactile presentation apparatus 100a to tactile presentation apparatus 100f) coupled for communication to the host apparatus 200 may each function as the first tactile presentation apparatus. In this manner, the plurality of tactile presentation apparatuses 100 may each function as the first tactile presentation apparatus, thereby enabling the host apparatus 200 to select an optimum tactile presentation apparatus 100 as the first tactile presentation apparatus.

### 1.3. Overview of Functions

Subsequently, description is given of an overview of functions of the information processing system according to the present embodiment.

First, consideration is given of an existing information processing system including a tactile presentation unit 20 that enables presentation of a tactile stimulus similarly to the tactile presentation unit 140 according to the present embodiment. The existing information processing system, in some cases, may not enable a user to properly perceive a direction of propagation of the tactile stimulus relative to the user.

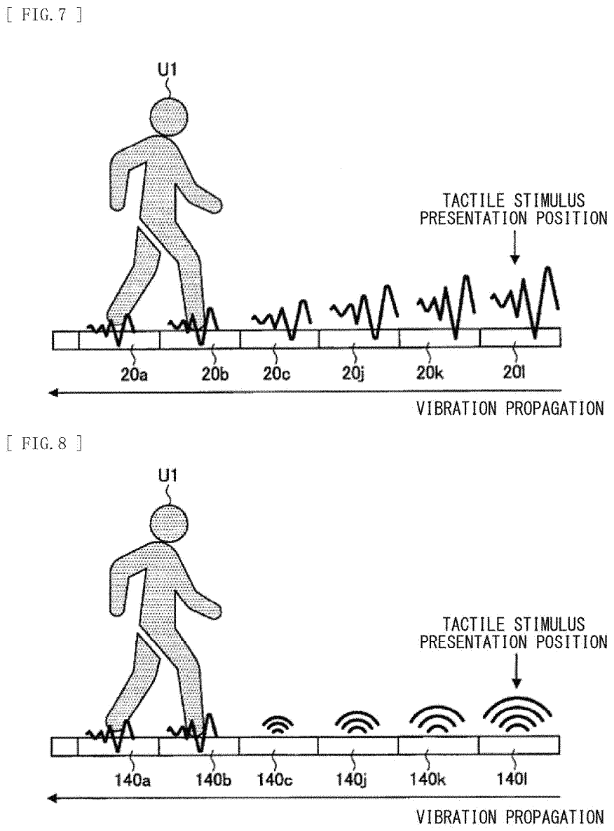

For example, a case is considered where a vibration presented to a desired vibration source (tactile stimulus presentation position) is propagated while being attenuated toward the user u1 as illustrated in FIG. 7 (in the example of FIG. 7, a vibration presented by a tactile presentation unit 20l is propagated to a tactile presentation unit 20k, a tactile presentation unit 20j . . . , and a tactile presentation unit 20a). The tactile presentation unit 20 basically presents a vibration using data in a band (low frequency band) less likely to be perceived by an auditory sense, and thus the user u1 is unable to perceive a direction in which the presented vibration is propagated, although the user u1 is able to perceive the vibration. Accordingly, the existing information processing system, in some cases, may not be able to provide a highly elaborate content.

In light of the above-described circumstances, the disclosing party of the present case has created a technique according to the present disclosure. The information processor according to the present embodiment enables a user to perceive a direction of propagation of a tactile stimulus relative to the user, by an auditory or visual effect, on the basis of a position of the user and a desired tactile stimulus presentation position.

For example, a case is considered where the tactile presentation unit 140 according to the present embodiment includes the actuator 10 (hereinafter, referred to as a “broadband actuator”) that is able to output data of frequency components in not only a non-audible range but also an audible range of a human. In this case, as illustrated in FIG. 8, the information processor according to the present embodiment is able to specify the tactile presentation units 140 (the tactile presentation unit 140a and the tactile presentation unit 140b in the example of FIG. 8) on which the user u1 is riding by a pressure-sensitive sensor or the like provided in the tactile presentation apparatus 100, cause the tactile presentation units 140 to present a vibration, and cause other tactile presentation units 140 (the tactile presentation unit 140c to the tactile presentation unit 140l in the example of FIG. 8) to present acoustics using acoustic information. In other words, the information processor according to the present embodiment causes the tactile presentation units 140 not used for presentation of the vibration, among the plurality of tactile presentation units 140, to output the data of the frequency component in the audible range of a human, thereby generating an auditory effect.

This enables user u1 to perceive, by means of acoustics to be presented, that a vibration presented to a desired vibration source (tactile stimulus presentation position) is propagated while being attenuated toward the user u1. In addition, it is difficult for the tactile presentation units 140 (the tactile presentation unit 140c to the tactile presentation unit 140l in the examples of FIG. 8) other than the tactile presentation units 140 on which the user u1 is riding to allow the user u1 to perceive the tactile stimulus. However, such tactile presentation units 140 are used to present acoustics, thus making it possible to effectively utilize each of the tactile presentation units 140. It is to be noted, in a case where the tactile presentation apparatus 100 or another external apparatus includes an acoustic output means such as a speaker, the information processor according to the present embodiment may use such an acoustic output means to present acoustics.

It should be noted that, as used herein, the “tactile stimulus presentation position” means a position where a tactile stimulus is actually presented or a position where a tactile stimulus is virtually presented. More specifically, the tactile stimulus presentation position may be a position where the tactile stimulus is actually presented by the tactile presentation unit 140, or may be a position where the tactile stimulus is virtually presented without the tactile stimulus being presented by the tactile presentation unit 140 (the tactile presentation unit 140l in the case of FIG. 8) as in the tactile stimulus presentation position illustrated in FIG. 8.

In addition, in a case where the tactile presentation apparatus 100 is provided with a configuration such as a display or a lamp, or a projection means that is able to project an image onto the tactile presentation apparatus 100 is provided in an external apparatus, the information processor according to the present embodiment may control the configurations to thereby allow the user u1 to perceive a direction of propagation of a vibration by a visual effect. More specifically, the information processor according to the present embodiment may use control information or the like for displaying an image or lighting a lamp to generate a visual effect in the configuration of the display, the lamp, or the like.

In addition, the tactile presentation apparatus 100 used for the generation of an auditory or visual effect may be, for example, the tactile presentation apparatus 100 positioned in a range where a tactile stimulus is propagated, but is not necessarily limited thereto (the tactile presentation apparatus 100 positioned outside the range where the tactile stimulus is propagated may be used). In addition, in the above description, the control related to the presentation of vibrations or acoustics is performed in a unit of the tactile presentation unit 140; however, the control may be performed in a unit of the actuator 10 provided in the tactile presentation unit 140.

Further, the information processor according to the present embodiment may allow the user to perceive not only the direction of propagation of the tactile stimulus relative to the user, but also a separation distance between the position of the user and the desired tactile stimulus presentation position, by an auditory or visual effect, on the basis of the position of the user and the desired tactile stimulus presentation position. For example, the information processor according to the present embodiment may localize a sound image to the tactile stimulus presentation position using sound image information as the acoustic information to thereby allow the user to also perceive the separation distance between the position of the user and the desired tactile stimulus presentation position. It is to be noted that the method for allowing the user to perceive the separation distance between the position of the user and the desired tactile stimulus presentation position is not limited thereto. For example, the information processor according to the present embodiment may adjust a sound volume of acoustics generated by each tactile presentation unit 140 to thereby allow the user to perceive the separation distance between the position of the user and the desired tactile stimulus presentation position.

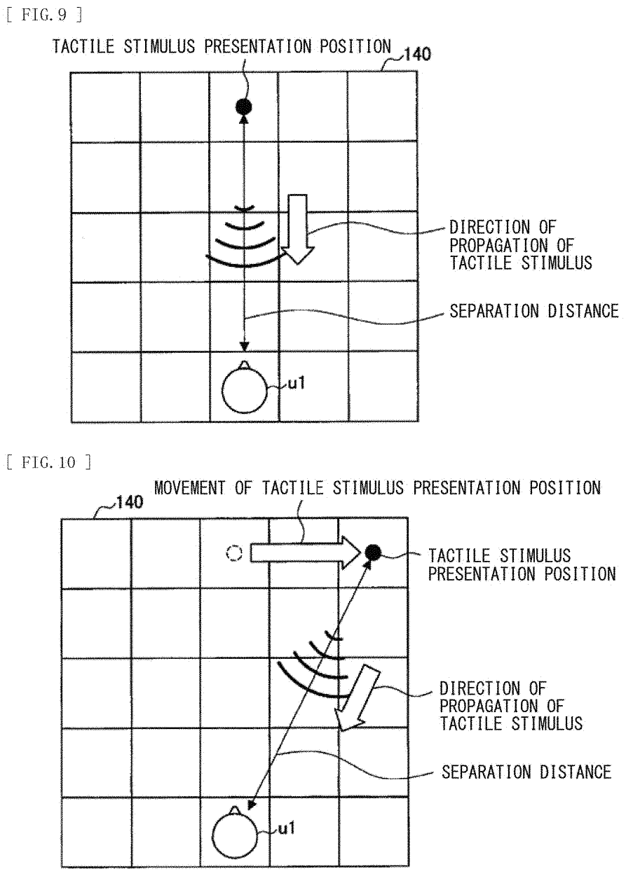

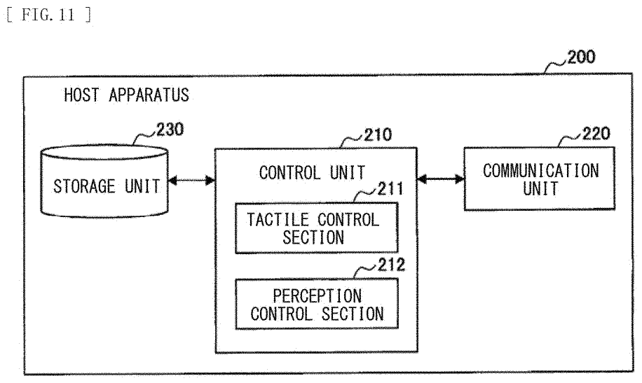

As illustrated in FIG. 9, the user u1 perceives the direction of propagation of the tactile stimulus relative to the user u1 (described as “direction of propagation of tactile stimulus” in FIG. 9) and the separation distance between the position of the user u1 and the desired tactile stimulus presentation position (described as “separation distance” in FIG. 9) to thereby be able to perceive the position of the tactile stimulus presentation position.

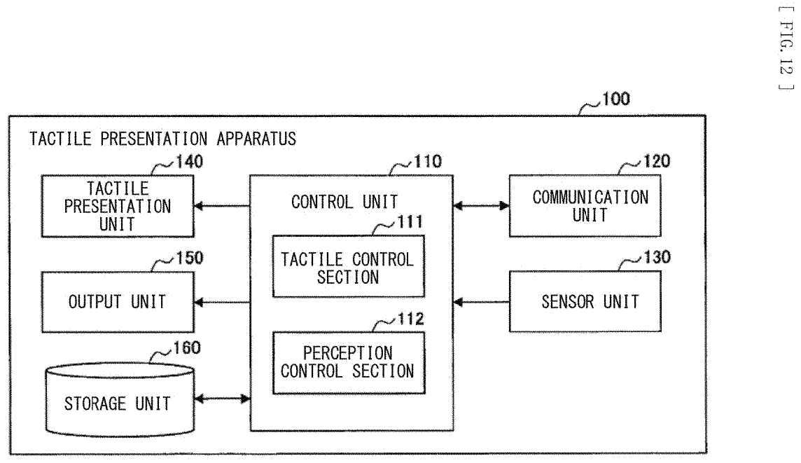

This enables the user u1 to also perceive a moving direction, a moving speed, and the like of the tactile stimulus presentation position on the basis of a change in the direction of propagation of the tactile stimulus and a change in the separation distance, in a case where the tactile stimulus presentation position is moved as illustrated in FIG. 10.

It is to be noted that an apparatus that implements the “information processor according to the present embodiment” described above is not particularly limited. For example, the tactile presentation apparatus 100 or the host apparatus 200, etc. described with reference to FIGS. 5 and 6 may implement the information processor according to the present embodiment. In the following, description is given by exemplifying a case where the tactile presentation apparatus 100 implements the information processor according to the present embodiment.

### 2. Configuration Example of Each Apparatus

The description has been given above of an overview of the present embodiment. Subsequently, description is given of a configuration example of each apparatus according to the present embodiment.

### 2.1. Configuration Example of Host Apparatus 200

First, description is given, with reference to FIG. 11, of a configuration example of the host apparatus 200. FIG. 11 is a block diagram illustrating the configuration example of the host apparatus 200. As illustrated in FIG. 11, the host apparatus 200 includes a control unit 210, a communication unit 220, and a storage unit 230. In addition, the control unit 210 includes a tactile control section 211 and a perception control section 212.

The control unit 210 is configured to collectively control overall processing to be performed by the host apparatus 200. For example, the control unit 210 is able to control activation and stop of each configuration. It is to be noted that the substance of the control by the control unit 210 is not particularly limited. For example, the control unit 210 may control processing (e.g., processing related to an OS (Operating System), etc.) typically performed in various servers, general-purpose computers, PCs (Personal Computer), tablet PCs, or the like.

The tactile control section 211 is configured to generate the tactile presentation information used for presentation of the tactile stimulus by the tactile presentation apparatus 100 existing at the tactile stimulus presentation position. Thereafter, in a case where another tactile presentation apparatus 100 presents a tactile stimulus to be propagated, another tactile presentation information generated on the basis of the tactile presentation information generated by the tactile control section 211 (or tactile presentation information generated by changing the tactile presentation information generated by the tactile control section 211) is used. The processing related to the propagation of the tactile stimulus is described in detail in later sections. The tactile control section 211 controls the communication unit 220 to thereby transmit the tactile presentation information to the first tactile presentation apparatus.

The perception control section 212 is configured to control processing related to various outputs (outputs other than a tactile stimulus) by the plurality of tactile presentation apparatuses 100. In addition to the tactile stimulus, the tactile presentation apparatus 100 is able to perform, for example, image display, acoustic output, and the like (not limited thereto). Therefore, the perception control section 212 generates control information (e.g., control information for displaying an image, control information for lighting a lamp, or acoustic information for outputting acoustics) to be used for various outputs by the tactile presentation apparatus 100 on the basis of the information concerning the progression status of the content provided from the content control apparatus 300, and controls the communication unit 220 to thereby transmit the control information to the first tactile presentation apparatus.

The communication unit 220 is configured to communicate with the content control apparatus 300 and the first tactile presentation apparatus. The communication unit 220 wirelessly communicates with these apparatuses directly or via a network access point in a system such as a wired LAN (Local Area Network), a wireless LAN, Wi-Fi (Wireless Fidelity, registered trademark), infrared communication, Bluetooth (registered trademark), or near field/contactless communication, for example.

The storage unit 230 is configured to store various types of information. For example, the storage unit 230 stores programs, parameters, or the like to be used by the control unit 210 or the communication unit 220. In addition, the storage unit 230 may store results of the processing by the control unit 210, information received from an external apparatus by the communication unit 220, and the like. It is to be noted that the substance of the information stored by the storage unit 230 is not limited thereto.

The description has been given above of the configuration example of the host apparatus 200. It is to be noted that the configuration described above with reference to FIG. 11 is merely an example, and the configuration of the host apparatus 200 is not limited to such an example. For example, the host apparatus 200 may not include some of the configurations illustrated in FIG. 11, or may include a configuration not illustrated in FIG. 11. In addition, the configuration illustrated in FIG. 11 may be provided in an external apparatus (unillustrated), and the host apparatus 200 may implement each of the functions described above by linking for communication to the external apparatus.

### 2.2. Configuration Example of Tactile Presentation Apparatus 100

Subsequently, description is given, with reference to FIG. 12, of a configuration example of the tactile presentation apparatus 100. FIG. 12 is a block diagram illustrating a configuration example of the tactile presentation apparatus 100. As illustrated in FIG. 12, the tactile presentation apparatus 100 includes a control unit 110, a communication unit 120, a sensor unit 130, the tactile presentation unit 140, an output unit 150, and a storage unit 160. In addition, the control unit 110 includes a tactile control section 111 and a perception control section 112. It is to be noted that either in a case of functioning as the first tactile presentation apparatus or in a case of functioning as the second tactile presentation apparatus, the tactile presentation apparatus 100 may have a similar configuration (configuration of FIG. 12). It should be noted that, unless otherwise specifically noted, subject matters described hereinafter apply to both of the first tactile presentation apparatus and the second tactile presentation apparatus.

The control unit 110 is configured to collectively control overall processing to be performed by the tactile presentation apparatus 100. For example, the control unit 110 is able to control activation and stop of each configuration. It is to be noted that the substance of the control by the control unit 110 is not particularly limited. For example, the control unit 110 may control processing (e.g., processing related to an OS) typically performed in various servers, general-purpose computers, PCs, tablet PCs, or the like.

The tactile control section 111 is configured to present the tactile stimulus to any target on the basis of the tactile presentation information. More specifically, in a case where the tactile presentation information generated by the host apparatus 200 is provided to the first tactile presentation apparatus, the tactile control section 111 of the first tactile presentation apparatus determines whether or not presentation of the tactile stimulus by an own apparatus is necessary (in other words, determines whether or not the own apparatus is the tactile presentation apparatus 100 existing at the tactile stimulus presentation position) on the basis of information (e.g., identification information on the tactile presentation apparatus 100, etc.) included in the tactile presentation information. Then, in a case where determination is made that the presentation of the tactile stimulus by the own apparatus is necessary, the tactile control section 111 controls the tactile presentation unit 140 on the basis of the tactile presentation information to thereby present the tactile stimulus.

In a case where determination is made that the presentation of the tactile stimulus by the own apparatus is not necessary, the tactile control section 111 of the first tactile presentation apparatus transmits the tactile presentation information to another peripheral tactile presentation apparatus 100 without presenting the tactile stimulus. In this manner, the tactile presentation information is linked for communication to the tactile presentation apparatus 100 existing at the tactile stimulus presentation position via one or the plurality of tactile presentation apparatuses 100, and the tactile control section 111 of the tactile presentation apparatus 100 existing at the tactile stimulus presentation position controls the tactile presentation unit 140 on the basis of the tactile presentation information to thereby present the tactile stimulus.

Thereafter, the tactile stimulus is propagated. To describe the way a tactile stimulus is propagated, in a case of receiving the tactile presentation information from the peripheral tactile presentation apparatus 100, the tactile control section 111 of the tactile presentation apparatus 100 (second tactile presentation apparatus) presenting the tactile stimulus presents a tactile stimulus on the basis of this tactile presentation information, further generates tactile presentation information reflecting a change in the tactile stimulus due to the propagation (e.g., attenuation of a vibration), and provides the generated tactile presentation information to another peripheral tactile presentation apparatus 100 (a tactile presentation apparatus 100 other than the tactile presentation apparatus 100 having transmitted the tactile presentation information). This allows for propagation of the tactile stimulus among the tactile presentation apparatuses 100.

It is to be noted that, as described with reference to FIG. 8, the tactile control section 111 causes the tactile presentation unit 140 on which the user is riding (touching) to present the tactile stimulus. More specifically, the tactile control section 111 specifies the tactile presentation unit 140 on which the user is riding by sensor information or the like of a pressure-sensitive sensor included in the sensor unit 130, and causes this tactile presentation unit 140 to present a vibration but does not cause other tactile presentation units 140 to present the tactile stimulus. It is difficult for the tactile presentation units 140 other than the tactile presentation unit 140 on which the user is riding to cause the user to perceive the tactile stimulus; however, the tactile control section 111 causes these tactile presentation units 140 not to present the tactile stimulus, thereby making it possible to reduce waste in the processing.

The perception control section 112 is configured to allow the user to perceive a direction of propagation of the tactile stimulus relative to the user, by an auditory or visual effect, on the basis of a position of the user and a desired tactile stimulus presentation position. To describe it more specifically, it is assumed that the tactile presentation apparatuses 100 specify the position of the user by the sensor information of the pressure-sensitive sensor included in each sensor unit 130 and share the position of the user among the tactile presentation apparatuses 100. In addition, it is assumed that the tactile presentation information to be diffused to each tactile presentation apparatus 100 stores information concerning the tactile stimulus presentation position. Then, on the basis of the position of the user and the desired tactile stimulus presentation position, the perception control section 112 causes the tactile presentation units 140 (the tactile presentation units 140 other than the tactile presentation unit 140 on which the user is riding) to output acoustics, and causes the output unit 150 to output images. It is to be noted that, the substances of the acoustics and the images to be outputted are decided on the basis of control information or the like provided from the host apparatus 200.

In addition, on the basis of the position of the user and the desired tactile stimulus presentation position, the perception control section 112 may allow the user to perceive not only the direction of propagation of the tactile stimulus relative to the user, but also the separation distance between the position of the user and the desired tactile stimulus presentation position, by an auditory or visual effect. For example, the perception control section 112 may control each configuration using sound image information included in the control information provided from the host apparatus 200 to localize a sound image to the tactile stimulus presentation position, for example, thereby allowing the user to perceive the separation distance between the position of the user and the desired tactile stimulus presentation position.

The communication unit 120 is configured to communicate with an external apparatus. More specifically, the communication unit 120 of the first tactile presentation apparatus communicates with the host apparatus 200 and another tactile presentation apparatus 100, and the tactile presentation apparatus 100 other than the first tactile presentation apparatus communicates with another tactile presentation apparatus 100. The communication unit 120 wirelessly communicates with these apparatuses directly or via a network access point in a system such as a wired LAN, a wireless LAN, Wi-Fi (registered trademark), infrared communication, Bluetooth (registered trademark), or near field/contactless communication, for example.

The sensor unit 130 is configured to acquire various types of sensor information. For example, providing the sensor unit 130 with a pressure-sensitive sensor enables the control unit 110 (including the tactile control section 111, the perception control section 112, etc.) to output whether or not the user is stepping on the tactile presentation apparatus 100, stepping force, a range and an area to which the force is applied, thus making it possible to control each of the configurations depending on results of these outputs. It is to be noted the type of the sensor included in the sensor unit 130 is not particularly limited.

The tactile presentation unit 140 is configured to present the tactile stimulus on the basis of the control by the tactile control section 111 and to present acoustics on the basis of the control by the perception control section 112. More specifically, the tactile presentation unit 140 is a broadband actuator that is able to output data of frequency components in not only a non-audible range but also an audible range of a human. It is to be noted that the tactile presentation unit 140 may be an electric element that presents a force sense, or may be a temperature change element (e.g., a Peltier element, etc.) that presents a temperature sense (in a case where the tactile presentation unit 140 is the electric element or the temperature change element, it is not possible to present acoustics, and thus the acoustics are presented by other configurations). In addition, the type of the tactile stimulus to be presented by the tactile presentation unit 140 is not particularly limited, as described above.

The output unit 150 is configured to perform various outputs on the basis of the control by the perception control section 112. For example, the output unit 150 includes a display means such as a display to thereby be able to perform various image displays, and includes an acoustic output means such as a speaker to thereby be able to perform various acoustic outputs (e.g., sound effects, etc.). It is to be noted that the output means included in the output unit 150 is not limited thereto.

The storage unit 160 is configured to store various types of information. For example, the storage unit 160 stores programs, parameters, or the like to be used by each of the configurations of the tactile presentation apparatus 1M. In addition, the storage unit 160 may store processing results of each of the configurations, information received from an external apparatus by the communication unit 120, and the like. It is to be noted that the substance of the information stored in the storage unit 160 is not limited thereto.

The description has been given above of the configuration example of the tactile presentation apparatus 100. It is to be noted that the above-described configuration described with reference to FIG. 12 is merely an example, and the configuration of the tactile presentation apparatus 100 is not limited to such an example. For example, the tactile presentation apparatus 100 may not include some of the configurations illustrated in FIG. 12, or may include a configuration not illustrated in FIG. 12. In addition, the configuration illustrated in FIG. 12 may be provided in an external apparatus (unillustrated), and the tactile presentation apparatus 100 may implement each of the functions described above by linking for communication to the external apparatus.

### 3. Example of Processing Flow of Each Apparatus

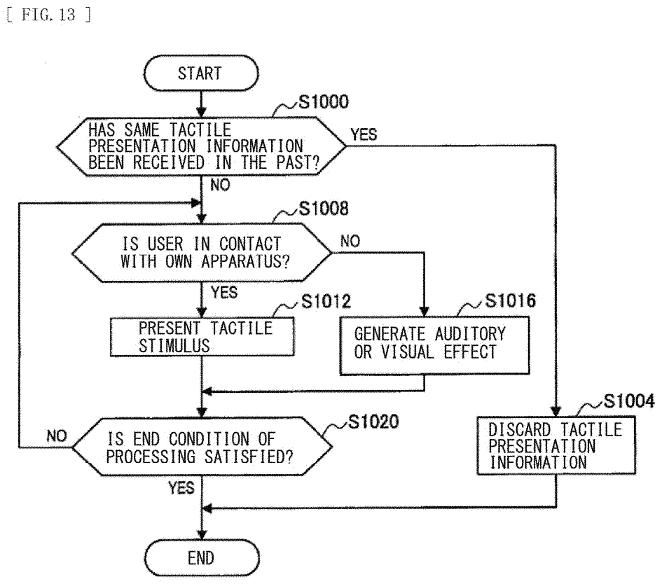

The description has been given above of the configuration example of each of the apparatuses according to the present embodiment. Subsequently, description is given, with reference to FIG. 13, of an example of a processing flow of each of the apparatuses according to the present embodiment, when presenting a tactile stimulus and an auditory or visual effect.

In step S1000, the tactile control section 111 of the tactile presentation apparatus 100 determines whether or not the same tactile presentation information has been received in the past. For example, the tactile control section 111 determines whether or not the same tactile presentation information has been received in the past on the basis of identification information on the tactile presentation information stored in the tactile presentation information. In a case where determination is made that the same tactile presentation information has been received in the past (step S1000/Yes), in step S1004, the tactile control section 111 discards the tactile presentation information. This prevents the same tactile stimulus from being presented in an overlapping manner using the same tactile presentation information.

When determination is made that the same tactile presentation information has not been received in the past (step S1000/No), in step S1008, the tactile control section 111 and the perception control section 112 determine whether or not a user is in contact with an own apparatus on the basis of sensor information or the like outputted by the sensor unit 130. In a case where determination is made that the user is in contact with the own apparatus (step S1008/Yes), in step S1012, the tactile control section 111 controls the tactile presentation unit 140 on the basis of the tactile presentation information to thereby present a tactile stimulus. In a case where determination is made that the user is not in contact with the own apparatus (step S1008/No), in step S1016, the perception control section 112 controls each of the configurations to thereby generate an auditory or visual effect.

In step S1020, the tactile control section 111 and the perception control section 112 determine whether or not an end condition of the processing by the own apparatus is satisfied. In a case where determination is made that the end condition of the processing by the own apparatus is not satisfied (step S1020/No), the tactile control section 111 and the perception control section 112 continue the processing from step S1008 to step S1016. In a case where determination is made that the end condition of the processing by the own apparatus is satisfied (step S1020/Yes), a series of processing by the tactile presentation apparatus 100 ends.

It is to be noted that, although not illustrated in FIG. 13, in a case where the tactile stimulus is propagated to another peripheral tactile presentation apparatus 100, the tactile control section 111 generates tactile presentation information used for presentation of the tactile stimulus by the other tactile presentation apparatus 100, and provides the generated tactile presentation information to the other tactile presentation apparatus 100.

### 4. Modification Examples

The description has been given above of the example of the processing flow of each of the apparatuses according to the present embodiment, when presenting the tactile stimulus and the auditory or visual effect. Subsequently, description is given of modification examples according to the present embodiment.

### 4.1. First Modification Example

First, description is given of a first modification example according to the present embodiment.

The description has been given above to the effect that the tactile presentation apparatus 100 used for the generation of the auditory or visual effect is, for example, the tactile presentation apparatus 100 positioned in a range where the tactile stimulus is propagated. In this system, however, in a case where a plurality of users utilize the information processing system according to the present embodiment, an auditory or visual effect generated for one user may interfere with a normal experience of another user in some instances.

For example, in FIG. 8 described above, in a case where the separation distance between the tactile presentation unit 140 generating acoustics and the user u1 is far, the tactile presentation unit 140 may not be able to allow the user u1 to perceive the acoustics, in some instances, unless the acoustics are generated at a large sound volume. At this time, when another user u2 exists near the tactile presentation unit 140, it follows that the acoustics of a large sound volume are generated near the user u2, thus resulting in interference with the normal experience of the user u2. For example, in FIG. 8, existence of the user u2 near the tactile presentation unit 140l generating the acoustics at a large sound volume interferes with the normal experience of the user u2.

Therefore, the perception control section 112 according to the first modification example decides a range of configurations to be controlled for generation of an auditory effect on the basis of a position of the user and a desired tactile stimulus presentation position. More specifically, the perception control section 112 according to the first modification example decides the tactile presentation units 140 to be controlled for the generation of the auditory effect, from among the plurality of tactile presentation units 140, on the basis of the position of the user and the desired tactile stimulus presentation position.

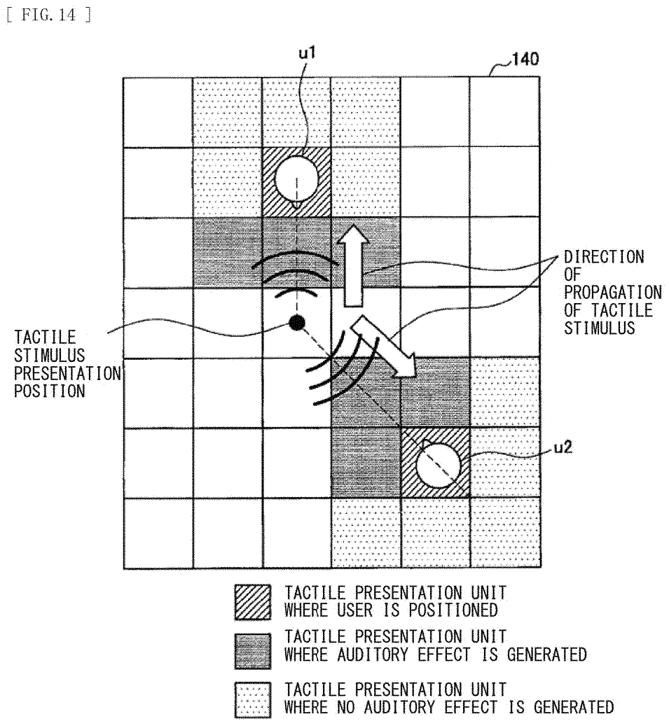

For example, before the time when the tactile stimulus reaches the user from the tactile stimulus presentation position, as illustrated in FIG. 14, the perception control section 112 according to the first modification example may decide a predetermined number of the tactile presentation units 140 positioned closer to the tactile stimulus presentation position, from among the tactile presentation units 140 surrounding the tactile presentation unit 140 where the user is positioned, as the tactile presentation units 140 to be controlled for the generation of the auditory effect.

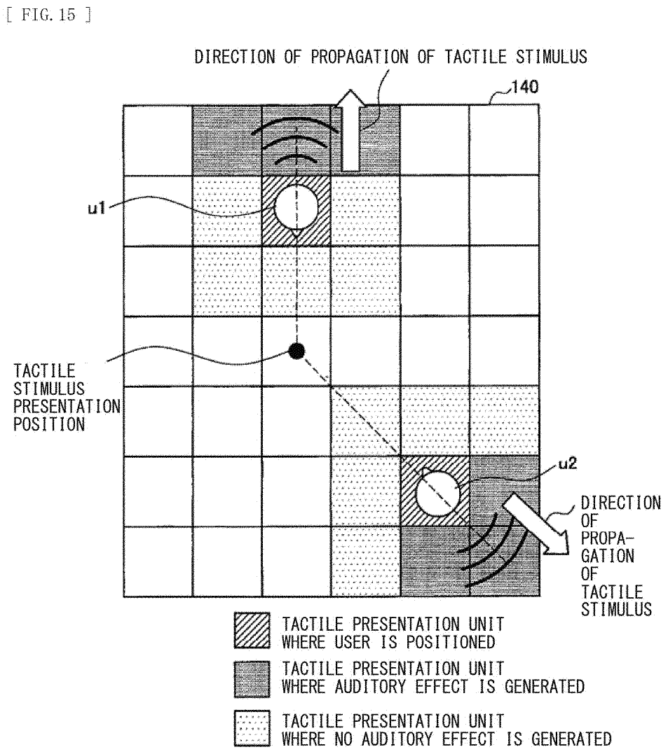

In addition, after the time when the tactile stimulus has reached the user, as illustrated in FIG. 15, the perception control section 112 may decide a predetermined number of the tactile presentation units 140 positioned farther from the tactile stimulus presentation position, from among the tactile presentation units 140 surrounding the tactile presentation unit 140 where the user is positioned, as the tactile presentation units 140 to be controlled for the generation of the auditory effect.

Then, the perception control section 112 adjusts a sound volume of acoustics to be generated by the tactile presentation unit 140 decided as a control target or localizes a sound image thereof, for example, thereby be able to allow the user to perceive that the tactile stimulus has propagated to the user and then has passed through the user. It is to be noted that the method for deciding the tactile presentation units 140 to be controlled for the generation of the auditory effect is not limited to the method described with reference to FIGS. 14 and 15.

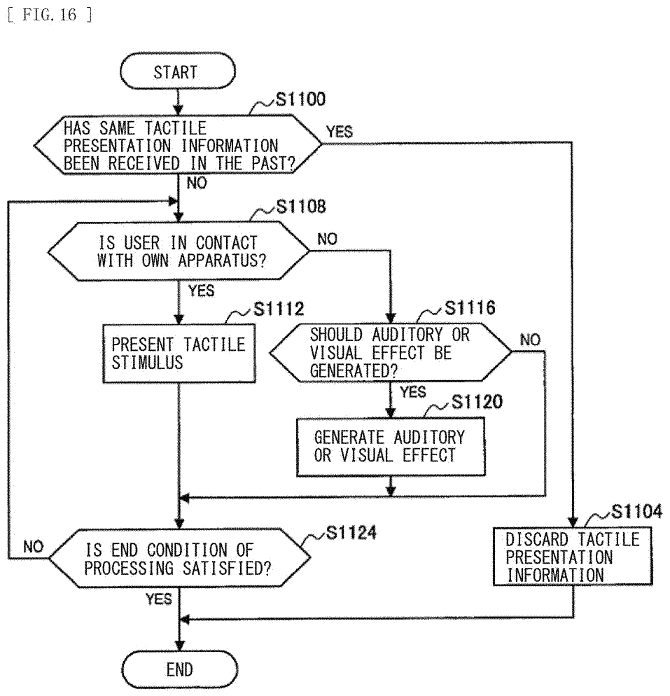

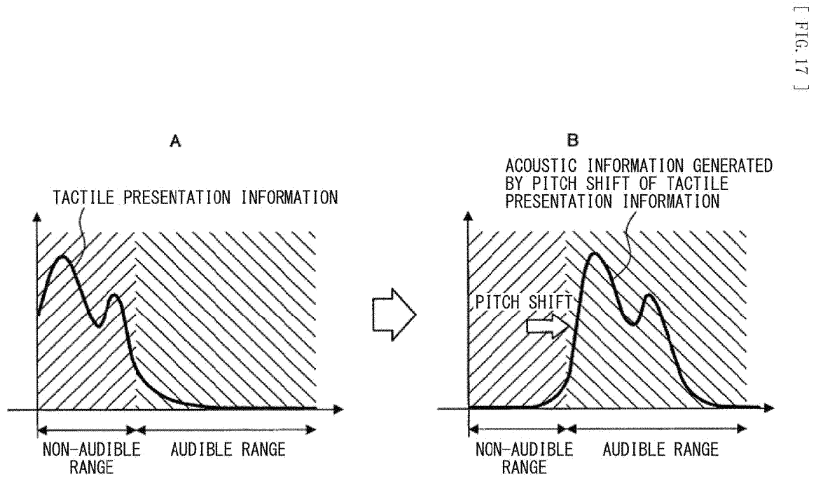

Subsequently, description is given, with reference to FIG. 16, of an example of a processing flow of each of the apparatuses according to the first modification example, when presenting a tactile stimulus and an auditory or visual effect.

In step S1100, the tactile control section 111 of the tactile presentation apparatus 100 determines whether or not the same tactile presentation information has been received in the past. In a case where determination is made that the same tactile presentation information has been received in the past (step S1100/Yes), in step S1104, the tactile control section III discards the tactile presentation information. This prevents the same tactile stimulus from being presented in an overlapping manner using the same tactile presentation information.

In a case where determination is made that the same tactile presentation information has not been received in the past (step S1100/No), in step S1108, the tactile control section 111 and the perception control section 112 determine whether or not a user is in contact with an own apparatus on the basis of sensor information or the like outputted by the sensor unit 130. In a case where determination is made that the user is in contact with the own apparatus (step S1108/Yes), in step S1112, the tactile control section 111 controls the tactile presentation unit 140 on the basis of the tactile presentation information to thereby present a tactile stimulus. In a case where determination is made that the user is not in contact with the own apparatus (step S1108/No), in step S1116, the perception control section 112 determines whether or not the own apparatus should generate an auditory or visual effect. For example, the perception control section 112 determines, for example, whether or not the tactile presentation unit 140 to be controlled for the generation of the auditory effect is provided, on the basis of a position of the user and a desired tactile stimulus presentation position.

In a case where determination is made that the own apparatus should generate the auditory or visual effect (step S1116/Yes), in step S1120, the perception control section 112 controls each of the configurations to generate the auditory or visual effect. In a case where determination is made that the own apparatus should not generate the auditory or visual effect (step S1116/No), the processing of step S1120 is omitted.

In step S1124, the tactile control section 111 and the perception control section 112 determine whether or not an end condition of the processing by the own apparatus is satisfied. In a case where determination is made that the end condition of the processing by the own apparatus is not satisfied (step S1124/No), the tactile control section 111 and the perception control section 112 continue the processing from step S1108 to step S1120. In a case where determination is made that the end condition of the processing by the own apparatus is satisfied (step S1124/Yes), a series of processing by the tactile presentation apparatus 100 ends.

It is to be noted that, although not illustrated in FIG. 16, in a case where the tactile stimulus is propagated to another peripheral tactile presentation apparatus 100, the tactile control section 111 generates tactile presentation information used for presentation of the tactile stimulus by the other tactile presentation apparatus 100, and provides the generated tactile presentation information to the other tactile presentation apparatus 100.

### 4.2. Second Modification Example

Subsequently, description is given of a second modification example according to the present embodiment.

The description has been given above to the effect that, in order to generate the auditory or visual effect, for example, control information (e.g., control information for displaying an image, control information for lighting a lamp, or acoustic information for outputting acoustics) is used, which is generated by the perception control section 212 of the host apparatus 200. However, the perception control section 212 of the host apparatus 200 may not be able to generate the control information, in some cases, from the viewpoint of a processing load or the like.

Therefore, on the basis of tactile presentation information (hereinafter, may be referred to as “first information” in some cases) used for presentation of a vibration (tactile stimulus) by the tactile presentation unit 140, the perception control section 112 according to the second modification example generates information (hereinafter, may be referred to as “second information” in some cases) for generation of an auditory or visual effect.

For example, the perception control section 112 according to the second modification example may move tactile presentation information that is mostly a frequency component in a non-audible range as illustrated in A of FIG. 17 toward side of an audible range by a predetermined frequency (hereinafter, this processing is referred to as a “pitch shift”), as illustrated in B of FIG. 17 to increase tactile presentation information that is a frequency component in an audible range, thereby generating the second information for generation of acoustics.

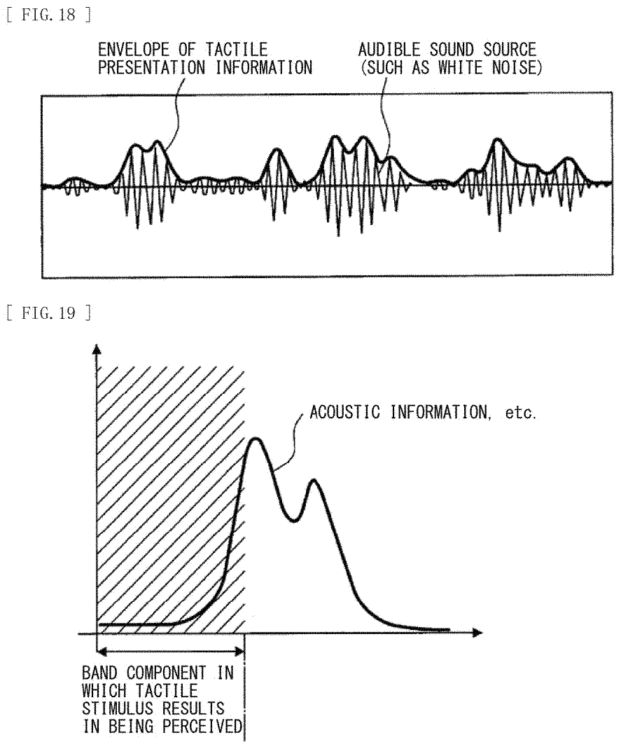

In addition, as illustrated in FIG. 18, the perception control section 112 according to the second modification example may analyze the tactile presentation information to thereby extract an envelope indicating an amplitude of the tactile presentation information, and performs mapping of an audible sound source (e.g., white noise, etc.) prepared in advance to the envelope to thereby generate the second information for the generation of acoustics.

In addition, the perception control section 112 according to the second modification example may convert information concerning output intensity, output frequency, or the like of the tactile stimulus stored in the tactile presentation information, in accordance with a predetermined algorithm to thereby generate the second information for displaying an image or lighting a lamp. This enables the perception control section 112 to control the substance of the image, the brightness of the lamp, or the like, in accordance with the output intensity or the output frequency of the tactile stimulus.

For example, in a case where the tactile presentation information (first information) is provided from the peripheral tactile presentation apparatus 100, the perception control section 112 according to the second modification example generates the second information immediately (in real time) in the various methods described above, and causes an auditory or visual effect to be generated. This enables the tactile presentation apparatus 100 to generate the auditory or visual effect to allow for perception of a direction of propagation, or the like of the tactile stimulus even in a case where the perception control section 212 of the host apparatus 200 is unable to generate the control information. It is to be noted that the method for generating the second information is not limited to the above-described examples.

### 4.3. Third Modification Example

Subsequently, description is given of a third modification example according to the present embodiment.

There may be a case where a user is unable to perceive a normal tactile stimulus due to generation of an auditory effect by the tactile presentation apparatus 100 to allow the user to perceive a direction of propagation, or the like of the tactile stimulus. For example, in a case where the tactile presentation apparatus 100 uses acoustic information to generate an auditory effect, as illustrated in FIG. 19, a low-frequency component (described as “band component in which tactile stimulus results in being perceived” in FIG. 19) included in the acoustic information may result in a tactile stimulus, that should not be perceived, being perceived by the user due to the component, in some cases.

Therefore, the perception control section 112 according to the third modification example distinctively controls a band component lower than a predetermined frequency and a band component equal to or higher than the predetermined frequency, among information used for generation of the auditory effect.

For example, the perception control section 112 according to the third modification example may output the band component lower than the predetermined frequency and the band component equal to or higher than the predetermined frequency from respective different configurations. More specifically, the perception control section 112 according to the third modification example may specify the position of the user using, for example, sensor information of the pressure-sensitive sensor provided in the sensor unit 130 to cause the band component lower than the predetermined frequency, in which a tactile stimulus is more likely to be perceived by the user, to be outputted from a configuration (e.g., a broadband actuator or a speaker) positioned farther from the user and to cause the band component equal to or higher than the predetermined frequency to be outputted from a configuration positioned closer to the user.

In addition, the perception control section 112 according to the third modification example may discard the low frequency component of the acoustic information without outputting the band component lower than the predetermined frequency because of a smaller auditory influence than the high frequency component.

### 4.4. Fourth Modification Example

Subsequently, description is given of a fourth modification example according to the present embodiment.

Although the description has been given above by exemplifying the case where the plurality of tactile presentation apparatuses 100 are arranged on the ground in a state of close proximity to one another as illustrated in FIG. 2, etc., an arrangement mode of the tactile presentation apparatuses 100 is not limited thereto. Therefore, in the fourth modification example according to the present embodiment, description is given of a case where the plurality of tactile presentation apparatuses 100 are arranged on a wear worn by a user, as a variation of the arrangement mode of the tactile presentation apparatuses 100.

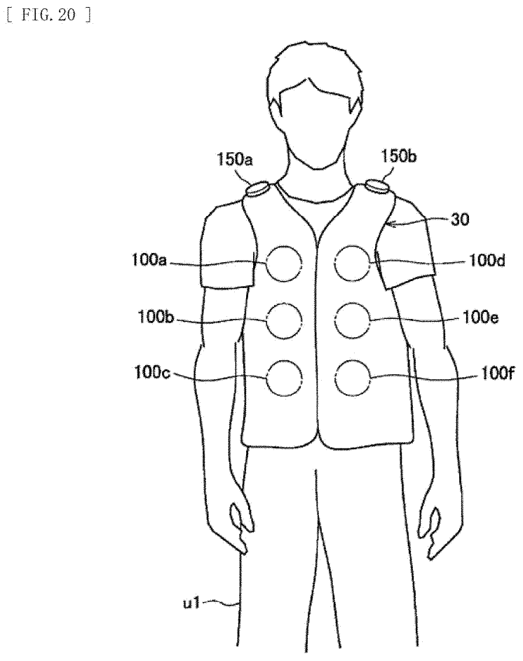

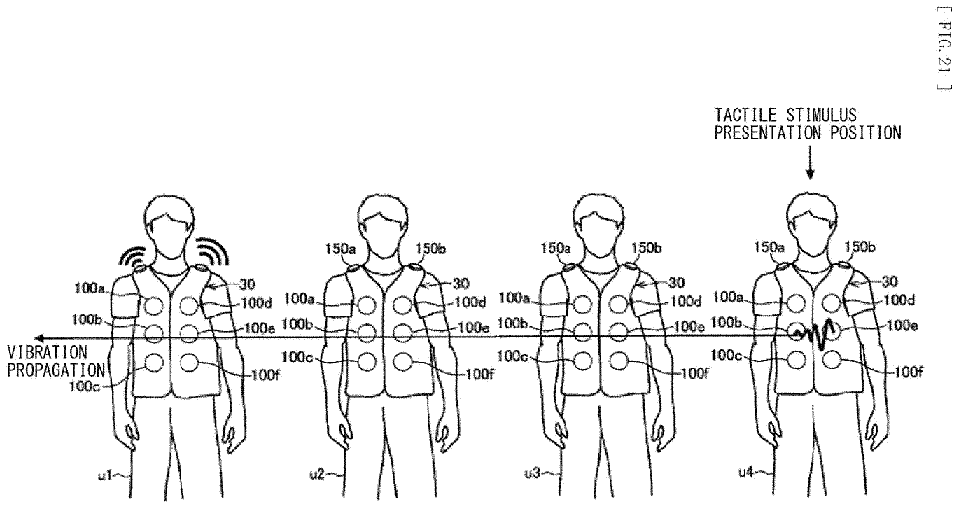

More specifically, as illustrated in FIG. 20, the plurality of tactile presentation apparatuses 100 (tactile presentation apparatus 100a to tactile presentation apparatus 100f in the example of FIG. 20) and a plurality of output units 150 (an output unit 150a and an output unit 150b being able to output a sound, in the example of FIG. 20) are arranged on a wear 30. For example, a predetermined number (e.g., six) of the tactile presentation apparatuses 10 may be arranged on each of front surface side and rear surface side of the user.

Also in the fourth modification example according to the present embodiment, similarly to those described above, the first tactile presentation apparatus is linked for communication to the host apparatus 200 and is further linked for communication to another tactile presentation apparatus 100 on the wear 30 of the same user to thereby propagate various types of information (e.g., tactile presentation information, control information, etc.) from the first tactile presentation apparatus as a starting point. This enables an information processing system according to the fourth modification example to propagate the tactile stimulus on the body of the user.

In addition, in a case where there are a plurality of users, the first tactile presentation apparatus on the wear 30 of one user is linked for communication to the host apparatus 200 and is further linked for communication to another tactile presentation apparatus 100 in each wear 30 of the same user and another user, which may enable propagation of various types of information from the first tactile presentation apparatus on the wear 30 of the one user. This enables the information processing system according to the fourth modification example to propagate the tactile stimulus among the plurality of users.

Also in the fourth modification example according to the present embodiment, similarly to those described above, the tactile presentation apparatus 100 allows the user to perceive a direction of propagation of the tactile stimulus relative to the user, by an auditory or visual effect. Here, in a case where the tactile stimulus is propagated among the plurality of users, the tactile presentation apparatuses 100 may not be able to allow the users to perceive acoustics at a far separation distance among the users, in some instances, unless the acoustics are generated at a large sound volume.

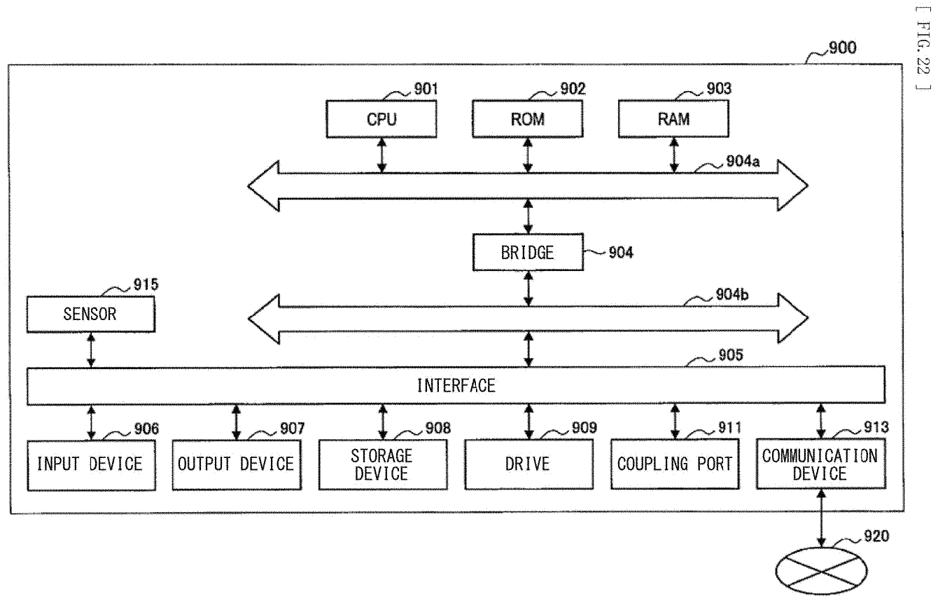

For example, it is assumed, in a situation where the user u1 to a user u4 are arranged side by side in a row, that a desired vibration is applied to the tactile presentation apparatuses 100 on the wear 30 of the user u4 (in other words, the tactile stimulus presentation position corresponds to the tactile presentation apparatuses 100 on the wear 30 of the user u4) as illustrated in FIG. 21. In addition, in a case where the vibration is propagated in the order of the user u4, the user u3, the user u2, and the user u1, acoustics outputted from the output units 150 (output unit 150a and output unit 150b) of each user to be in conjunction with the propagation may result in interference with the normal experience of each user, in some instances, as the acoustics have a larger sound volume.

Therefore, in order to generate an auditory effect, the perception control section 112 according to the fourth modification example controls only the output units 150 on the wear 30 worn by a target user who is allowed to perceive a direction of propagation of the tactile stimulus. In the example of FIG. 21, the perception control section 112 according to the fourth modification example controls the output units 150 on the wear 30 worn by the user u1 to generate acoustics, thereby allowing the user u1 to perceive that the tactile stimulus (vibration) is propagated in the order of the user u4, the user u3, the user u2, and the user u1 (i.e., a direction of propagation of a vibration, etc.). This prevents the interference with normal experiences of other users.

### 5. Hardware Configuration Example

The description has been given above of the modification examples according to the present embodiment. Finally, description is given, with reference to FIG. 22, of a hardware configuration example of the tactile presentation apparatus 100 or the host apparatus 200 according to the present embodiment described above. FIG. 22 is a block diagram illustrating a hardware configuration example of an information apparatus 900 embodying the tactile presentation apparatus 100 or the host apparatus 200 according to the present embodiment. Information processing by the tactile presentation apparatus 100 or the host apparatus 200 according to the present embodiment is implemented by cooperation between software and hardware described below.

As illustrated in FIG. 22, the information apparatus 900 includes a CPU (Central Processing Unit) 901, a ROM (Read Only Memory) 902, a RAM (Random Access Memory) 903, and a host bus 904a. In addition, the information apparatus 900 includes a bridge 904, an external bus 904b, an interface 905, an input device 906, an output device 907, a storage device 908, a drive 909, a coupling port 911, a communication device 913, and a sensor 915. The information apparatus 900 may include, in place of or in addition to the CPU 901, a processing circuit such as a DSP or an ASIC.

The CPU 901 functions as an arithmetic processor and a controller, and controls overall operations in the information apparatus 900 in accordance with various programs. In addition, the CPU 901 may be a microprocessor. The ROM 902 stores programs to be used by the CPU 901, arithmetic parameters, and the like. The RAM 903 temporarily stores programs to be used in execution by the CPU 901, parameters appropriately changed in the execution, and the like. The CPU 901 may embody, for example, the control unit 110 of the tactile presentation apparatus 100 or the control unit 210 of the host apparatus 200.

The CPU 901, the ROM 902 and the RAM 903 are coupled mutually by the host bus 904a including a CPU bus, or the like. The host bus 904a is coupled to the external bus 904b such as a PCI (Peripheral Component Interconnect/Interface) bus via the bridge 904. It is to be noted that it is not necessarily required to configure the host bus 904a, the bridge 904, and the external bus 904b to be separated; these functions may be mounted in one bus.

The input device 906 may be implemented by, for example, a device to which information is inputted by a user, such as a mouse, a keyboard, a touch panel, a button, a microphone, a switch, and a lever. In addition, the input device 906 may be, for example, a remote control device utilizing infrared rays or other radio waves, or may be an externally coupled device such as a mobile phone or a PDA compatible with operations of the information apparatus 900. Further, the input device 906 may include, for example, an input control circuit that generates an input signal on the basis of information inputted by a user who uses the input means described above and outputs the generated input signal to the CPU 901. By operating this input device 906, the user of the information apparatus 900 is able to input various data to the information apparatus 900 or to give an instruction of a processing operation.

The output device 907 is formed by a device that is able to visually or auditorily notify the user of acquired information. Examples of such a device include a display device such as a CRT display device, a liquid crystal display device, a plasma display device, an EL display device, and a lamp, an acoustic output device such as a speaker and a headphone, and a printing device, etc. In addition, in the present embodiment, the output device 907 may be formed by an actuator that presents a vibration, an electric element that presents a stimulus related to a force sense, a temperature change element that presents a stimulus related to a temperature, or the like. The output device 907 may embody, for example, the tactile presentation unit 140 or the output unit 150 of the tactile presentation apparatus 100.

The storage device 908 is a device for storing data formed as an example of a storage unit of the information apparatus 900. The storage device 908 is implemented by, for example, a magnetic storage unit device such as an HDD, a semiconductor storage device, an optical storage device, a magneto-optical storage device, or the like. The storage device 908 may include a storage medium, a recorder that records data in the storage medium, a reader that reads the data from the storage medium, a deleting device that deletes the data recorded in the storage medium, and the like. The storage device 908 stores programs to be executed by the CPU 901, various data, various data acquired from the outside, and the like. The storage device 908 may embody, for example, the storage unit 160 of the tactile presentation apparatus 100 or the storage unit 230 of the host apparatus 200.

The drive 909 is a reader/writer for a storage medium, and is built in or externally attached to the information apparatus 900. The drive 909 reads information recorded in an attached removable storage medium such as a magnetic disk, an optical disk, a magneto-optical disk, or a semiconductor memory, and outputs the read information to the RAM 903. In addition, the drive 909 is also able to write information into the removable storage medium.

The coupling port 911 is an interface to be coupled to an external apparatus, and is a coupling port with an external apparatus that is able to transmit data by, for example, a USB (Universal Serial Bus), etc.

The communication device 913 is, for example, a communication interface formed by a communication device, etc. for coupling to a network 920. The communication device 913 is, for example, a communication card, etc. for wired or wireless LAN (Local Area Network), LTE (Long Term Evolution), Bluetooth (registered trademark), or WUSB (Wireless USB). In addition, the communication device 913 may be a router for optical communication, a router for ADSL (Asymmetric Digital Subscriber Line), a modem for various types of communication, or the like. The communication device 913 is able to transmit and receive signals or the like to and from the Internet or other communication apparatuses in accordance with a predetermined protocol such as TCP/IP, for example. The communication device 913 may embody, for example, the communication unit 120 of the tactile presentation apparatus 100 or the communication unit 220 of the host apparatus 200.

The sensor 915 is, for example, each of various sensors such as a pressure-sensitive sensor, an acceleration sensor, a gyro sensor, a geomagnetic sensor, an optical sensor, a sound sensor, or a distance measuring sensor. The sensor 915 acquires information concerning a status of the information apparatus 900 itself, such as a posture and a traveling speed of the information apparatus 900, as well as information concerning an ambient environment of the information apparatus 900, such as ambient brightness and noise of the information apparatus 900. In addition, the sensor 915 may include a GPS sensor that receives a GPS signal to measure latitude, longitude, and altitude of the apparatus. The sensor 915 may embody, for example, the sensor unit 130 of the tactile presentation apparatus 100.

It is to be noted that the network 920 is a wired or wireless transmission path for information transmitted from an apparatus coupled to the network 920. For example, the network 920 may include a public network such as the Internet, a telephone network, a satellite communication network, various types of LAN (Local Area Network) including Ethernet (registered trademark), WAN (Wide Area Network), and the like. In addition, the network 920 may include a private network such as IP-VPN (Internet Protocol-Virtual Private Network).

The description has been given above of the example of the hardware configuration that makes it possible to implement the functions of the information apparatus 900 according to the present embodiment. Each of the above-described components may be implemented using general-purpose members, or may be implemented by hardware specialized in the functions of the respective components. Accordingly, it is possible to appropriately change hardware configurations to be utilized in accordance with a technical level at the time of implementing the present embodiment.

It is to be noted that it is possible to create a computer program for implementing each function of the information apparatus 900 according to the present embodiment as described above and to mount the computer program on a PC, etc. In addition, it is also possible to provide a computer-readable recording medium in which such a computer program is stored. The recording medium is, for example, a magnetic disk, an optical disk, a magneto-optical disk, a flash memory, or the like. In addition, the computer program described above may be distributed via a network, for example, without using a recording medium.

### 6. Conclusion

As described above, the information processor according to the present embodiment enables a user to perceive a direction of propagation of a tactile stimulus relative to the user, by an auditory or visual effect, on the basis of a position of the user and a desired tactile stimulus presentation position. In addition, the information processor according to the present embodiment may allow the user to perceive not only the direction of propagation of the tactile stimulus relative to the user, but also a separation distance between the position of the user and the desired tactile stimulus presentation position. This enables the information processor according to the present embodiment to provide a highly elaborate content. It is to be noted that the present disclosure is able to achieve not only this effect but also various effects described hereinabove.

Although the description has been given above in detail of preferred embodiments of the present disclosure with reference to the accompanying drawings, the technical scope of the present disclosure is not limited to such examples. It is obvious that a person having ordinary skill in the art of the present disclosure may find various alterations or modifications within the scope of the technical idea described in the claims, and it should be understood that these alterations and modifications naturally come under the technical scope of the present disclosure.

In addition, the effects described herein are merely illustrative or exemplary, and are not limitative. That is, the technology according to an embodiment of the present disclosure may achieve, in addition to or in place of the above effects, other effects that are obvious to those skilled in the art from the description of the present specification.

It is to be noted that the technical scope of the present disclosure also includes the following configurations.

(1)

An information processor including a perception control section that allows, on a basis of a position of a user and a desired tactile stimulus presentation position, the user to perceive a direction of propagation of the tactile stimulus relative to the user, by an auditory effect or a visual effect.

(2)

The information processor according to (1), in which the desired tactile stimulus presentation position includes a position where the tactile stimulus is actually presented, or a position where the tactile stimulus is virtually presented.

(3)

The information processor according to (1) or (2), in which the perception control section allows, on the basis of the position of the user and the desired tactile stimulus presentation position, the user to perceive not only the direction of the propagation of the tactile stimulus relative to the user, but also a separation distance between the position of the user and the desired tactile stimulus presentation position, by the auditory effect or the visual effect.

(4)

The information processor according to any one of (1) to (3), in which the perception control section decides, on the basis of the position of the user and the desired tactile stimulus presentation position, a range of a configuration to be controlled for generation of the auditory effect.

(5)

The information processor according to any one of (1) to (4), in which the tactile stimulus includes a vibration.

(6)

The information processor according to (5), in which the perception control section causes a vibration presentation unit not used for the presentation of the vibration, among a plurality of the vibration presentation units allowing for the presentation of the vibration, to output data of a frequency component in an audible range of a human to thereby generate the auditory effect.

(7)

The information processor according to (6), in which the perception control section decides, on the basis of the position of the user and the desired tactile stimulus presentation position, the vibration presentation unit to be controlled for the generation of the auditory effect, among the plurality of the vibration presentation units.

(8)

The information processor according to (6) or (7), in which the perception control section generates second information for generation of the auditory effect or the visual effect on a basis of first information used for the presentation of the vibration by the vibration presentation unit.

(9)

The information processor according to any one of (1) to (8), in which the perception control section distinctively controls a band component lower than a predetermined frequency and a band component equal to or higher than the predetermined frequency, among information used for the generation of the auditory effect.

(10)

An information processing method executed by a computer, the method including allowing, on a basis of a position of a user and a desired tactile stimulus presentation position, the user to perceive a direction of propagation of the tactile stimulus relative to the user, by an auditory effect or a visual effect.

(11)

A storage medium storing a program that causes a computer to implement allowing, on a basis of a position of a user and a desired tactile stimulus presentation position, the user to perceive a direction of propagation of the tactile stimulus relative to the user, by an auditory effect or a visual effect.

### REFERENCE NUMERALS LIST

100 tactile presentation apparatus
110 control unit
111 tactile control section
112 perception control section
120 communication unit
130 sensor unit
140 tactile presentation unit
150 output unit
160 storage unit
200 host apparatus
210 control unit
211 tactile control section
212 perception control section
220 communication unit
230 storage unit
300 content control apparatus

1. An information processor comprising a perception control section that allows, on a basis of a position of a user and a desired tactile stimulus presentation position, the user to perceive a direction of propagation of a tactile stimulus relative to the user, by an auditory effect or a visual effect.

2. The information processor according to claim 1, wherein the desired tactile stimulus presentation position comprises a position where the tactile stimulus is actually presented, or a position where the tactile stimulus is virtually presented.

3. The information processor according to claim 1, wherein the perception control section allows, on the basis of the position of the user and the desired tactile stimulus presentation position, the user to perceive not only the direction of the propagation of the tactile stimulus relative to the user, but also a separation distance between the position of the user and the desired tactile stimulus presentation position, by the auditory effect or the visual effect.

4. The information processor according to claim 1, wherein the perception control section decides, on the basis of the position of the user and the desired tactile stimulus presentation position, a range of a configuration to be controlled for generation of the auditory effect.

5. The information processor according to claim 1, wherein the tactile stimulus comprises a vibration.

6. The information processor according to claim 5, wherein the perception control section causes a vibration presentation unit not used for presentation of the vibration, among a plurality of the vibration presentation units allowing for the presentation of the vibration, to output data of a frequency component in an audible range of a human to thereby generate the auditory effect.

7. The information processor according to claim 6, wherein the perception control section decides, on the basis of the position of the user and the desired tactile stimulus presentation position, the vibration presentation unit to be controlled for the generation of the auditory effect, among the plurality of the vibration presentation units.

8. The information processor according to claim 6, wherein the perception control section generates second information for generation of the auditory effect or the visual effect on a basis of first information used for the presentation of the vibration by the vibration presentation unit.

9. The information processor according to claim 1, wherein the perception control section distinctively controls a band component lower than a predetermined frequency and a band component equal to or higher than the predetermined frequency, among information used for generation of the auditory effect.

10. An information processing method executed by a computer, the method comprising allowing, on a basis of a position of a user and a desired tactile stimulus presentation position, the user to perceive a direction of propagation of a tactile stimulus relative to the user, by an auditory effect or a visual effect.

11. A storage medium storing a program that causes a computer to implement allowing, on a basis of a position of a user and a desired tactile stimulus presentation position, the user to perceive a direction of propagation of a tactile stimulus relative to the user, by an auditory effect or a visual effect.
